(19) United States
(12) Patent Application Publication
(10) Pub. No.: US 2026/0351287 A1
(43) Pub. Date: Nov. 5, 2026

(54) SYSTEMS AND METHODS FOR MEDIA PURIFICATION

(71) Applicants: Michael Rochelle, Eastvale, CA (US); Aaron Drake, Jr., Lake View Terrace, CA (US)

(72) Inventors: Michael Rochelle, Eastvale, CA (US); Aaron Drake, Jr., Lake View Terrace, CA (US)

(21) Appl. No.: 19/136,247

(22) PCT Filed: May 22, 2025
(86) PCT No.: PCT/US2025/030668

§ 371 Date: Jun. 5, 2025

Related U.S. Application Data
(60) Provisional application No. 63/650,580, filed on May 22, 2024.

(51) Int. Cl. G11B 27/036; G06V 20/40; G10L 15/08; G10L 25/57

(52) U.S. Cl. CPC G11B 27/036; G06V 20/41; G10L 15/08; G10L 25/57; G10L 2015/088

(57) ABSTRACT

A method for purifying media includes chunking the media into chunks. The method further includes detecting an undesirable object in a chunk and identifying a location of the undesirable object in the respective chunk. The method further includes removing or replacing the undesirable object within the chunk. The method further includes recombining the chunks to create purified media. The method further includes outputting the purified media.

### CROSS-REFERENCE TO RELATED APPLICATIONS

This application is a National Phase entry from PCT Application No. PCT/US25/30668, titled SYSTEMS AND METHODS FOR MEDIA PURIFICATION and filed May 22, 2025, and also claims the benefit and priority of U.S. Provisional Application No. 63/650,580, titled SYSTEMS AND METHODS FOR MEDIA PURIFICATION and filed May 22, 2024, the entire disclosure of both being expressly incorporated by reference herein in their entirety.

### BACKGROUND

### Field

The present disclosure is directed to systems and methods for purifying media and, more particularly, to systems and methods for using artificial intelligence (AI) to remove portions of media content.

### Description of Related Art

Art of various types may include material that is not suitable for all audiences. For example, video or image media may include naked body parts, music media may include curse words, or the like. In some situations, it may be desirable to purify the art before distribution to certain groups. Purification may obscure the media so as to remove the unsuitable material. For example, radio programs may replace curse words with sound effects so young listeners are not exposed to the curse words. This purification is conventionally performed by humans. This manual editing of media can be tedious, and certain unsuitable material may be missed during the purification process due to human error. In addition, certain purification techniques may reduce the quality of the media.

Thus, there is a need in the art for systems and methods for automatic media purification.

### SUMMARY

Described herein is a method for purifying media. The method includes chunking the media into chunks. The method further includes detecting an undesirable object in a chunk and identifying a location of the undesirable object in the respective chunk. The method further includes removing or replacing the undesirable object within the chunk. The method further includes recombining the chunks to create purified media. The method further includes outputting the purified media.

In any of the foregoing embodiments, chunking the media into chunks includes chunking the media into dynamic chunks to avoid splitting at least one of full objects or undesirable objects into more than one chunk.

Any of the foregoing embodiments may further include: separating each of the dynamic chunks into its meaningful parts, wherein detecting the undesirable object and removing or replacing the undesirable object are both performed within a meaningful part of a dynamic chunk; and recombining the respective meaningful part with remaining meaningful parts to recreate the chunks before recombining the chunks.

In any of the foregoing embodiments: the media includes audio; the undesirable object includes an identified word; and the meaningful parts include at least one vocals meaningful part and at least one instrumental meaningful part such that a recombined chunk includes the entirety of the instrumental meaningful part and the vocals meaningful part with the identified word being removed or replaced.

Any of the foregoing embodiments may further include enhancing at least a portion of the meaningful parts to ease identification of objects in the meaningful parts.

In any of the foregoing embodiments, the media includes video media, and the undesirable object includes an identified shape.

In any of the foregoing embodiments, removing or replacing the undesirable object includes replacing the identified shape with a computer-generated acceptable shape.

In any of the foregoing embodiments, the media includes audio media, the undesirable object is a word or phrase, and removing or replacing the undesirable object includes replacing the word or phrase with at least one of: a pre-recorded sound bite; a version of the word or phrase that has been reversed to sound like a new word or phrase; a different word or phrase obtained from at least one of the audio media or a creator of the media; or a computer-generated acceptable replacement word or phrase.

In any of the foregoing embodiments, the media includes audio media, the undesirable object includes multiple different words or phrases, and removing or replacing the undesirable object includes selecting one of multiple actions based on identification of the word or phrase that corresponds to the respective undesirable object.

In any of the foregoing embodiments, the media includes a combination of video media and audio media, and chunking the media into chunks further includes separating the video media and the audio media from the media such that at least one of the video media or the audio media can be analyzed to identify the undesirable object.

In any of the foregoing embodiments, detecting the undesirable object is performed using a contextual recognition algorithm.

Also disclosed is a system for processing media. The system includes a media source configured to provide access to a piece of media. The system further includes an output device configured to output a clean version of the piece of media. The system further includes a processor coupled to the media source and the output device and configured to: chunk the media into chunks, detect an undesirable object in a chunk and identify a location of the undesirable object in the respective chunk, remove or replace the undesirable object within the chunk, and recombine the chunks to create the clean version of the piece of media.

Any of the foregoing embodiments may further include an input device configured to receive identification data identifying undesirable objects and to receive treatment data indicating how each undesirable object of the identified undesirable objects is to be treated, wherein the processor is configured to detect the undesirable object based on the received identification data and to remove or replace the undesirable object based on the treatment data.

In any of the foregoing embodiments, the processor is further configured to perform a contextual recognition algorithm to detect the undesirable object.

In any of the foregoing embodiments, the processor is configured to chunk the media into dynamic chunks to avoid splitting at least one of full objects or undesirable objects into more than one chunk.

In any of the foregoing embodiments, the processor is further configured to: separate each of the dynamic chunks into its meaningful parts, such it detects the undesirable object and removes or replaces the undesirable object within a meaningful part of a dynamic chunk; and recombine the respective meaningful part with remaining meaningful parts to create the chunks before recombining the chunks.

In any of the foregoing embodiments, the media includes video media, the undesirable object includes an identified shape, and the processor is further configured to remove or replace the undesirable object by at least one of: removing the undesirable object; replacing the undesirable object with a computer-generated acceptable shape; or replacing the undesirable object with a pre-identified acceptable shape.

In any of the foregoing embodiments, the media includes audio media, the undesirable object is a word or phrase, and the processor is further configured to remove or replace the undesirable object by replacing the word or phrase with at least one of: a pre-recorded sound bite; a version of the word or phrase that has been reversed to sound like a new word or phrase; a different word or phrase obtained from at least one of the audio media or a creator of the media; or a computer-generated acceptable replacement word or phrase.

In any of the foregoing embodiments, the media includes audio media, the undesirable object includes multiple different words or phrases, and the processor is further configured to remove or replace the undesirable object by selecting one of multiple actions based on identification of the word or phrase that corresponds to the respective undesirable object.

Also disclosed is a method for processing media. The method includes receiving or accessing a piece of media that includes at least one of audio or video. The method further includes chunking the media into dynamic chunks to avoid splitting at least one of full objects or undesirable objects into more than one chunk. The method further includes detecting an undesirable object in a chunk. The method further includes identifying a location of the undesirable object in the respective chunk. The method further includes removing or replacing the undesirable object within the chunk. The method further includes recombining the chunks to create purified media. The method further includes outputting the purified media.

### BRIEF DESCRIPTION OF THE DRAWINGS

Other systems, methods, features, and advantages of the present disclosure will be or will become apparent to one of ordinary skill in the art upon examination of the following figures and detailed description. It is intended that all such additional systems, methods, features, and advantages be included within this description, be within the scope of the present disclosure, and be protected by the accompanying claims. Component parts shown in the drawings are not necessarily to scale, and may be exaggerated to better illustrate the important features of the present disclosure. In the drawings, like reference numerals designate like parts throughout the different views, wherein:

FIG. 1 is a block diagram illustrating a system for purifying media, according to various embodiments of the present disclosure;

FIG. 2 is a block diagram illustrates components of an exemplary computing device, according to various embodiments of the present disclosure;

FIG. 3 is flowchart illustrating a method for purifying media, according to various embodiments of the present disclosure;

FIG. 4 is a representation of dynamic chunking, according to various embodiments of the present disclosure;

FIG. 5 is a block diagram illustrating exemplary operation of the method of FIG. 3 regarding audio media, according to various embodiments of the present disclosure;

FIG. 6 is a block diagram illustrating exemplary operation of the method of FIG. 3 regarding video media, according to various embodiments of the present disclosure; and

FIG. 7 is a table illustrating exemplary actions for treatment of undesirable objects, according to various embodiments of the present disclosure.

### DETAILED DESCRIPTION

The present disclosure describes systems and methods for automatic media purification. The systems and methods may be configured to purify any type of media such as video, audio, images, or the like. The systems may utilize artificial intelligence (AI) in the purification process. This automatic purification provides various benefits and advantages over conventional purification techniques. For example, the purification does not require any human time or effort, thus reducing manpower needed to purify a piece of media. In addition, the systems and methods may be designed to only remove or obscure the unsuitable portion of the media, thus not reducing the quality of the remaining media (e.g., voice alone may be removed from music, thus keeping the remaining sounds, such as instruments, in their original format). The systems also advantageously allow for various configurations such that an unsuitable segment may be removed, obscured, replaced, or the like depending on a preference of the user. The configurability also beneficially allows a user to define unsuitable versus suitable material, thus providing the user full control over operation of the systems. The systems and methods can advantageously be applied to any form of media such as audio, video, or any other media format. The systems also beneficially work with media from any source such as an external storage device (e.g., compact disk, external hard drive, universal serial bus (USB) key, or the like), a streaming source, a remote device (such as a remote database), or the like.

An exemplary system includes a media source that provides access to one or more piece of media, such as a data port, a storage medium, a disk drive, or the like. The system may also include an output device that outputs the media; the output device may include, for example, a display, a speaker, a radio broadcast, a data port, or the like. The system may also include a processor that is designed to purify media. The processor may perform several actions such as chunking the media into chunks and potentially separating each chunk into meaningful parts. The processor may also analyze each chunk to identify or detect any undesirable objects in the respective chunks. The processor may also remove or replace each detected undesirable object to purify the media, and may provide the purified media to the output device. Where used herein, an “object” refers to any identifiable piece of media; for example, an object in audio may include a word or sound, and an object in video may include a shape or other image.

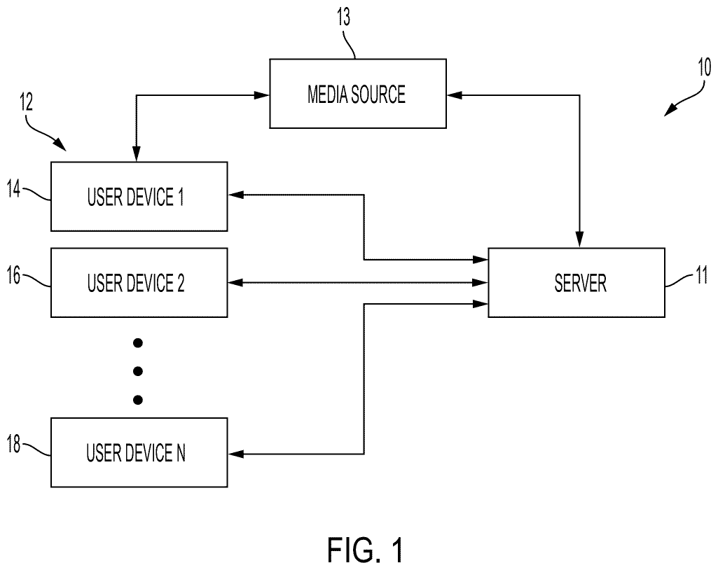

Turning to FIG. 1, a system 10 for purifying media is shown. The system 10 may be designed to handle any one or more type of media such as audio media, video media, image media, or the like. The system 10 may include a server 11, one or more user devices 12 (including a first user device 14, a second user device 16, and a third user device 18), and one or more media sources 13. The server 11 may be coupled to the user devices 12 and, in some embodiments, may be coupled to the media source 13. In some embodiments, the server 11 may perform the purification process, in some embodiments, the user devices 12 may handle the purification process, and in some embodiments, the server 11 and the user devices 12 may work together to handle the purification process. In that regard, the system 10 may operate with just one or more user devices 12 and one or more media source 13 (which may be included as part of the user devices 12); the system 10 may likewise operate with just a server 11 and one or more media source 14 (which may be included as part of the server 11).

The server 11 may include any one or more server and may be positioned at one location or distributed as part of a distributed server architecture. In some embodiments, the server 11 may be designed to perform artificial intelligence (AI) functions such as perception, reasoning, learning, problem solving, decision-making, language understanding, automation, data analysis, or the like. In that regard, the server 11 may perform specific AI functions such as machine learning algorithms, large language model (LLM) algorithms, natural language processing (NLP) algorithms, speech recognition algorithms, computer vision algorithms, contextual recognition algorithms, or the like. In that regard and as discussed in more detail below, the server 11 may include application-specific hardware (e.g., application specific integrated circuits (ASIC)) or general purpose hardware programmed with application specific programming or software (e.g., general purpose processors with a memory that stores a purification algorithm). The server may include non-transitory memory that stores instructions usable by the processor or controller to perform logic functions, as well as storing data as requested by the processor or controller.

The user devices 12 may include any user devices that may be operated by a user that can at least one of receive user input or output media to a user. For example, the user devices 12 may include a desktop computer, a laptop computers, a smartphone, an infotainment system in a vehicle, a home stereo receiver, a control unit usable by a disk jockey at a radio station to broadcast media over radio waves, or the like. In some embodiments, the user devices 12 may include their own digital logic devices (e.g., controllers or processors and non-transitory memory) that can perform some or all of the media purification algorithms. Each user device 12 may be similar or different devices; for example, the first user device 14 may be a home computer, the second user device 16 may be a smartphone, and the third user device 18 may be a control unit at a radio station headquarters. Each user device 12 may be in digital communication with the server 11 and may thus at least one of transmit data to the server 11 or receive data from the server 11.

The media source 13 may include any source that stores, streams, or otherwise provides media. The media may include any media including at least one of audio media, video media, image media, any combination thereof, or any additional or alternative media. The media source 13 may include, for example, a digital storage device such as an external hard drive, a universal serial bus (USB) key, a non-transitory memory device of the user devices 12 or the server 110, a separate database that stores media, or the like. The media source 13 may also or instead include external storage devices such as a compact disc (CD), a digital versatile disc (DVD) a tape, a record, or the like. The media source 13 may also or instead include a port (such as on a user device 12 or a separate port that is connectable to a user device 12 via a wired or wireless connection) that can receive streaming media from an external source; the port may include, for example, a FM or AM radio receiver, a Wi-Fi or Ethernet port that can receive streaming media from the Internet, a satellite radio receiver, or the like. In some embodiments, the media source 13 may be integral with the user device 12 (e.g., a non-transitory memory of the user device 12), may be connected to the user device 12 (e.g., if the media source 13 is a USB key), may be remote from the user device 12 (e.g., if the server 11 stores media), or the like.

As described in more detail below, the system 10 is designed to purify media. That is, the system 10 may identify objects within media (such as words, images, shapes, or the like) that are undesirable and may remove or replace the undesirable objects. The system 10 configurable such that a user can assign certain objects as undesirable (e.g., a naked body, a word BADWORD1 but not BADWORD2, or the like). The system 10 may be designed to be used by any type of user that accesses or plays media. For example, a first user device 14 may include a laptop on which a minor child streams video-a parent may set up the user device 14 to remove or replace any identified naked bodies, any drugs, and any drug paraphernalia. As another example, a second user device 16 may include a disk jockey (DJ) setup that transmits a music broadcast, and the DJ may set up the user device 16 to remove or replace any undesirable word from a list of undesirable words (and the DJ may assign words as undesirable or not). As yet another example, a third user device 18 may include a car stereo system; a user may set up the user device 18 to not output any undesirable words (which may be assigned by the user) regardless of whether the music is from a radio broadcast, a CD, or a smartphone.

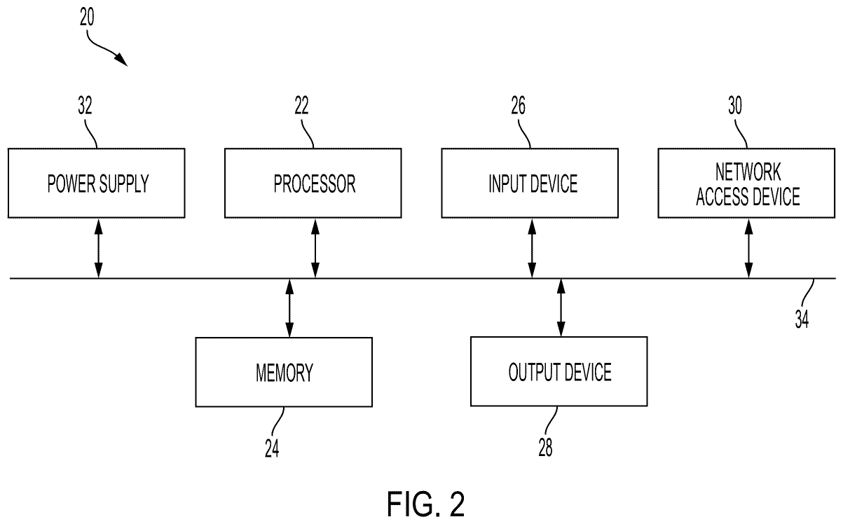

Referring now to FIG. 2, an exemplary computing device 20 is shown. Any one or more computing device described herein (e.g., the server 11, some or all of the user devices 12, the media source 13, or the like) may include some or all of the features of the computing device 20.

The computing device 20 may include a controller or processor 22. The processor 22 may include any controller or processor capable of performing logic functions. For example, the processor 22 may include an application-specific integrated circuit (ASIC), a general-purpose processor, a field programmable gate array (FPGA), a digital signal processor (DSP), a graphics processing unit (GPU), any combination of discrete logic devices that perform logic functions, or the like. In some embodiments, the processor 22 may further include a memory that stores instructions usable by the processor 22 to perform logic functions. The processor 22 may be housed within the electronic device 20, may be remote and provide remote functionality (e.g., by providing cloud-based processing), or any combination thereof.

The computing device 20 may further include a non-transitory memory 24. The memory 24 may include any non-transitory memory such as random-access memory (RAM), dynamic random-access memory (DRAM) read-only memory (ROM), or any other type of memory. The memory 24 may be housed within the electronic device 20, may include remote memory (e.g., cloud-based memory), may be external relative to the electronic device 20 (e.g., an external hard drive), or any combination thereof. The memory may store information usable by the processor 22 to perform logic functions, may store information as requested by the processor for later retrieval, or the like.

The computing device 20 may further include an input device 26. The input device 26 may include any one or more input device such as a mouse, a keyboard, a touchscreen, a microphone, or the like. The input device 26 may receive input from a user and convert the input into digital signals usable by the processor 22. For example, a user may use an input device 26 of a user device 12 to toggle media purification on and off, to identify undesirable objects to be removed or replaced, or the like.

The computing device 20 may further include an output device 28. The output device 28 may include any one or more output device such as a display, a touchscreen, a printer, a speaker, or the like. The output device 28 may receive digital information from the processor 22 and may convert the digital information into a format that can be interpreted by a user. In some embodiments, the output device 28 may output purified media. In some embodiments, the output device 28 may create a physical object that includes the media; for example, the output device 28 may burn a CD, a store media in a USB key, save media on a digital audio tape (DAT), or the like. In that regard, the device 20 may output multiple copies of the purified media for distribution or other use.

The computing device 20 may also include a network access device 30. The network access device 30 may include one or more device capable of communicating with external elements via any wired or wireless protocol. For example, the network access device 30 may communicate via Ethernet, Bluetooth®, Wi-Fi, universal serial bus (USB), or the like. In that regard, the network access device 30 may communicate with the processor 22, may transmit information from the processor 22 to a remote device as requested by the processor 22, and may transmit information from a remote device to the processor 22. The network access device 30 may communicate with remote devices (e.g., may communicate with a remote server via the internet), may communicate with local devices (e.g., may communicate with a local printer), or the like.

In some embodiments and referring briefly to FIGS. 1 and 2, the network access device 30 may also function as an output device 28. For example, the network access device 30 may distribute media to one or more end user, such as via a radio broadcast, an internet stream, or the like. In that regard, media from a media source 13 may be provided to a network access device 30 that then broadcasts the media from the media source 13 such that end users may receive the broadcast media. Depending on the specific setup, the media source 13 may stream the media through a user device 12, in which case at least one of the media source 13 or the user device 12 may purify the media before broadcast. The media source 13 may also stream the media directly without interacting with a user device 12; in these embodiments, the media source 13 may purify the media. The media source 13 may also stream the media through the server 11 (e.g., the media source 13 may include a database and the server 11 may broadcast or stream the media); in these embodiments, at least one of the media source 13 or the server 11 may purify the media.

Returning reference to FIG. 2, the computing device 20 may further include a power supply 32. The power supply is designed to provide power to the computing device 20, such as by providing electricity usable by the components of the computing device 20 to function. The power supply 32 may include any power supply such as a cable and transformer designed to receive power from a wall socket, a battery, a supercapacitor, or any alternative or additional power supply.

The computing device 20 may also include connections or a bus 34. The connections or bus 34 may be connected to some or all components of the computing device 20 and may transmit at least one of a power signal or a data signal between components of the computing device. For example, power from the power supply 32 may be transmitted to the various components via the connections or bus 34, the processor may control the output device 28 by placing instructions on the connections or bus 34, or the like. The components of the computing device 20 may communicate with each other using any protocol on the connections or bus 34.

Referring to FIGS. 1 and 2, a memory 24 may store instructions usable by a processor 22 to purify media. In particular, the memory 24 may store instructions usable by the processor 22 to perform any functions discussed throughout this disclosure. The memory 24 may also store a list of undesirable objects to remove or replace along with desired actions for each undesirable object. For example and as discussed further below, the system 10 may be designed to perform different functions for different undesirable objects: it may be designed to remove any instances of BADWORD1, replace any instances of BADWORD2 with a reversal of the word (i.e., “2DROWDAB”), and replace any instances of BADWORD3 with a sound bite (such as a ringing bell).

Any component of the system 10 may perform the purification. In some embodiments, a processor 22 of a user device 12 may perform the purification without accessing the server 11. In that regard, a memory 24 of the user device 12 may store instructions usable by the processor 22 of the user device 12 to remove or replace any identified undesirable objects in the media. In some embodiments, the user device 12 may transmit the media to the server 11 for purification, may receive the purified media from the server 11, and then may output the purified media using an output device 28 of the user device 12 (or may broadcast the purified media, such as via radio frequency transmissions). In some embodiments, the server 11 may broadcast the media to a general audience, in which case the server 11 may perform the purification. In that regard, the system 10 may operate as a software as a service (SaaS) platform in which media is transmitted to the server 11 which then purifies the media, may operate as downloaded or downloadable software on an end-user device 12, or any combination thereof (e.g., part of the purification may occur on a user device 12 and another part may occur on the server 11).

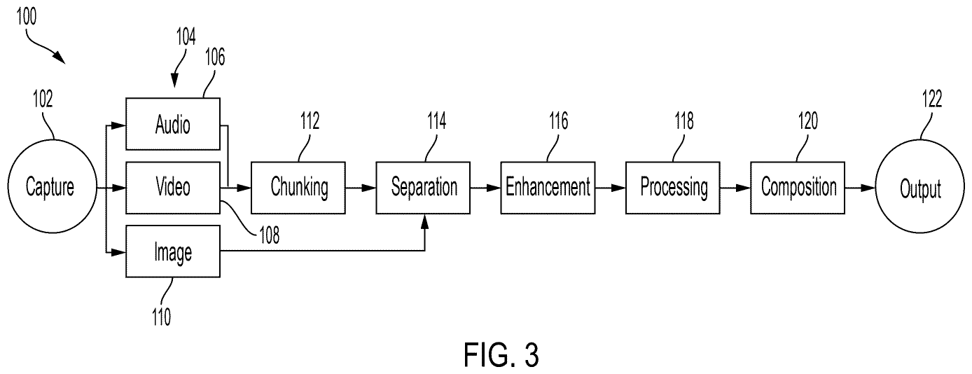

Turning now to FIG. 3, an exemplary method 100 for automatic media purification is shown. The method 100 may be used by a system such as the system 10 of FIG. 1 to purify any type of media such as video, images, audio, or the like. The method 100 may be implemented using hardware, software, firmware, or any combination thereof. In that regard, the method 100 may be implemented using a system that includes at least one of an input device, an output device, an input/output port, a controller or processor, a memory (e.g., a non-transitory memory), or the like, such as a device similar to the device 20 of FIG. 2.

The method 100 may be implemented using dedicated or application-specific hardware, general purpose hardware, remote hardware, or the like. The method 100 may utilize machine learning or other artificial intelligence (AI) algorithms to aid in any portion of the method 100, for example, to detect, separate, and eliminate or replace dirty, undesirable, or impure content. Because of the specific systems and methods disclosed herein, the method 100 may separate and remove or replace undesirable content, leaving the rest of the content intact in its original form (e.g., removal of vocal curse words does not affect instrumental sounds).

In block 102, media may be captured. Capturing media may refer to the media being acquired or accessed, such as via a stream. The media may be acquired, for example, at a location having computing equipment that is designed to perform the method 100. As described above, the media may be acquired using any means. For example, the media may be provided on a removable storage device (e.g., a universal serial bus (USB) key, a compact disk (CD), or the like). As another example, the media may be received from a live feed (e.g., from a live television (TV) or radio feed). As yet another example, the media may be received via a stream (e.g., over the internet using a service such as Spotify or Pandora). In block 102, media may be captured, acquired, or accessed, using any known means and from any known source.

Occasionally, a single piece of media may include multiple types of media that are combined together. For example, a video may include a moving image component and an audio component. In some embodiments, it may be desirable to split the combined media into the separate component media types. In that regard and in block 104, the media components may be separated. For example, the media may be separated into an audio component 106, a video component 108, and an image component 110. In some embodiments, the components may remain combined together and may be processed as combined media. The separation in block 104 may be performed using any known method. In some embodiments, the media may be provided with each of the components already separated such that the separation in block 104 is unnecessary.

In block 112, the media may be subjected to a chunking process. Chunking is a way to split the media into meaningful parts for processing. In that regard, each chunk (or part) may be processed by the method 100. For example, a 5-minute song may be divided into chunks of between 0.05 seconds and 30 seconds, between 0.5 seconds and 15 seconds, between 1 second and 10 seconds, or the like. In some embodiments, the media may be divided into chunks based on buffer size. In that regard, a chunk may be selected to be a similar size as the buffer size, may be selected such that multiple chunks may fit in the buffer, may be selected such that a percentage (e.g., 50 percent) of a chunk may fit in the buffer, or the like. For example, a 5-minute song may be divided into chunks of between 500 bytes and 1 megabyte (MB), between 1 kilobyte (KB) and 500 KB, between 5 KB and 30 KB, or the like.

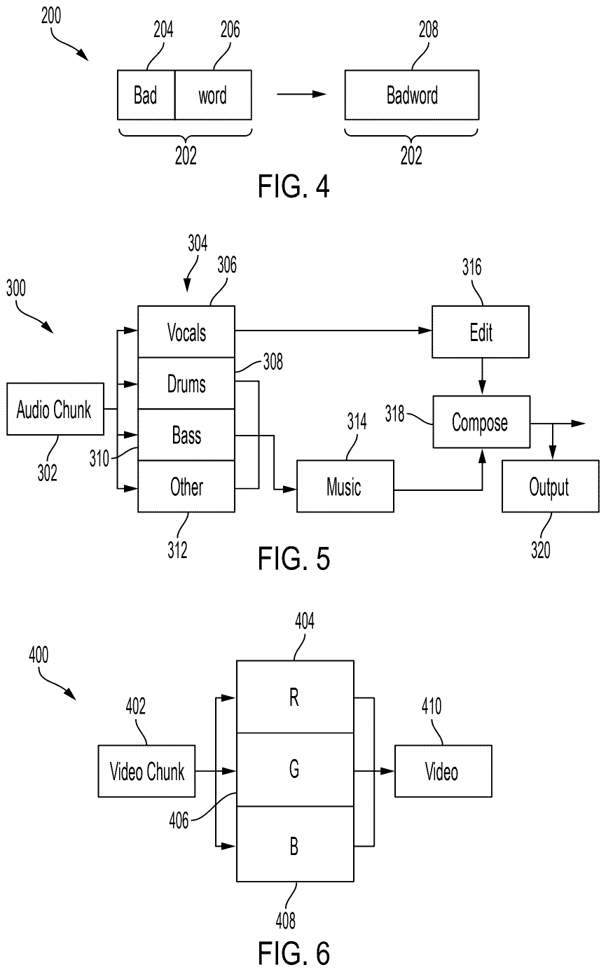

Conventional chunking processes may divide the media into a predefined buffer size. For example, in conventional chunking, a song may be split into chunks of 5 KB. However, due to the desired operation of the method 100 (purification of the media), it would be undesirable to split integral pieces of content into separate chunks. For example, if purification of the media for a specific application calls for removing all instances of the word “ricochet,” then it would be undesirable for one chunk to include “rico” and a separate chunk to include “chet” because the instance of “ricochet” may be missed altogether due to the separation. In that regard and as further described below, the chunking performed in block 112 may be designed to avoid splitting integral pieces of content into separate chunks. This chunking therefore reduces the likelihood of future processing missing any content of interest (e.g., the instance of “ricochet” mentioned above will not be missed). FIG. 4 provides a visual representation of this dynamic chunking. An undesirable word (e.g., a “badword”) 202 may be found within the media. A conventional chunking algorithm may divide the undesirable word 202 into a first chunk 204 and a second chunk 206, for example, if the “bad” portion completed a first chunk and the “word” portion began in a second chunk. However, the chunking in block 112 ensures that the undesirable word 202 remains in one chunk 208 and is not split into multiple chunks.

In order to avoid splitting integral content into separate chunks and with returned reference to FIG. 3, the method 100 may dynamically size the chunks around the meaningful content. That is, the size of the chunks may vary based on the content of the respective chunks and the content of adjacent chunks. The process used to dynamically size the chunks reduces the likelihood of meaningful content being split into two or more chunks (e.g., each chunk may include only whole words such that words are not split between chunks, or a full object in an image is not split between two or more chunks). In some embodiments, certain words (or other media) may be split into two or more chunks while undesirable words (or other objects) are never split. Chunks of media that have been dynamically chunked may be referred to as dynamic chunks.

Before any chunking occurs, the method 100 may use an algorithm to detect the activity of interest. For example, an artificial intelligence (AI) system, such as a system that incorporates a neural network, may be used to identify the activity of interest in the media (e.g., any words, separate video scenes, undesirable words, or other undesirable objects). The algorithm may be incorporated as part of the chunking block 112, or may be performed outside of the chunking block 112 and work in tandem with the chunking block 112. The chunking algorithm may receive the identified activity of interest and may dynamically select chunks (which may include chunk sizes) based on the identified activity of interest.

In block 114, each chunk of the media may be split into parts for processing. For example and referring to FIG. 5, an exemplary chunk 302 of audio may be divided into a vocals part 304 which includes audio signals relating to vocals, a drums part 308 which includes audio signals relating to drums, a bass part 310 which includes audio signals relating to bass guitar or other low-frequency audio, and another part 312 which includes audio signals relating to any other sounds (e.g., keyboards, wood instruments, a xylophone, or the like). The parts may be selected using any known mechanism such as separation by instrument type, separation by frequency, only separating human singing from all other media, or the like. As another example and referring to FIG. 6, video may be separated by color. For example, an exemplary chunk 402 of video may be divided into a red part 404, a green part 406, and a blue part 408. In some embodiments, video may remain in original chunks and not be separated by type.

Returning reference to FIG. 3, any known techniques may be used in the separation block 114. For example, audio separation may be performed using filters for various frequencies (e.g., frequencies between 1 Kilohertz (1 KHz) and 10 KHz may be filtered to create a first part, frequencies between 10 KHz and 20 KHz may be filtered to create a second part, etc.). As another example, audio separation may be performed using stems separation. Stems separation provides for isolating and separating layers in a track (e.g., an audio chunk may be split into drums, bass, melody, and vocals), and providing independent control over each layer. In some embodiments, block 114 separates the media into predetermined parts (e.g., bass, drums, melody, and vocals) and, in some embodiments, a user may define the parts to be separated in block 114.

In block 116, at least a portion of the separated parts of each chunk may be enhanced. Any known enhancement technique may be used. In some embodiments, only certain parts may be enhanced; for example, each vocal part may be enhanced while other parts remain in their original format. As another example, only vocal parts in chunks that are identified as having a potential undesirable object are enhanced. The enhancement of block 116 enhances or optimizes the signals for optimal processing and later composition. For example, vocals may be subjected to a vocal enhancement process which includes algorithms such as dynamic range compression, amplification, contrast, or the like. As another example, video signals may be subjected to a video enhancement process which increases contrast, brightness, edge detection, or the like. This enhancement may increase the likelihood of any undesirable objects being identified. In some embodiments, block 116 may be optional. When included, the enhancement block 116 optimizes content for the purpose of processing in block 118. For example, the speech parts of each chunk may be enhanced before subjecting them to a speech recognition model to optimize performance of the processing in the model. That is, the enhancement of the speech may result in a speech recognition algorithm being better able to interpret the speech than if the original speech portion was used without enhancement.

After enhancement in block 116, at least a portion of the separated parts may be processed in block 118. In some embodiments, only certain parts may be processed; for example, each vocal part may be processed while other parts remain in their original format. As another example, certain high-pitched sounds may trigger epileptic seizures and may thus be identified as undesirable objects; in this example, only parts that have a frequency above a predetermined threshold frequency may be processed. Because the non-vocal parts most likely do not include any undesirable speech content, only applying the processing 118 to speech portions of the media saves processing and memory requirements, and thus reduces a cost of operating the method 100. The processing of block 118 detects the undesirable objects (such as impure content) in the media. In some embodiments and to identify the undesirable objects, the vocal parts of each chunk of audio media may be subjected to speech recognition algorithms, where each word is recognized and timestamped and its duration being identified. As another example, for video media, the parts of each chunk may be subjected to object recognition algorithms where each object is detected and identified, categorized, and segmented where the specific location, height, and width of each object is identified and labeled with a timecode, duration, and path.

The parts of the media may be compared with a list of impure, or undesirable, objects during processing 118. For example, words identified in the vocal portions of each chunk may be compared with a list of undesirable objects (such as impure words). As another example, the detected objects in video chunks may be compared with identifiers of impure images (or shapes associated with undesirable objects). The list of undesirable objects may be configurable such that a user of the method 100 may determine their own list of undesirable objects, allowing a user of the method 100 to customize its operation. That is, a certain word, phrase, or shape may be set as an undesirable object by one user (and thus removed from, or replaced in, the media), and identified as acceptable by another user (and thus remain in the media). In some embodiments, the method 100 may allow a user to select a type or level of purification (e.g., maximum purification, minimum purification, purification to comply with federal communications commission (FCC) rules regarding broadcasting, purification for users under 18 years old, etc.), and the method 100 may purify the media based on the type or level of purification. The method 100 may determine how to purify the media based on the type or level of purification based on pre-programmed rules, by accessing specific rules on a server, or the like. For example, a set of rules may include a list of undesirable objects to be removed for the selected level, general guidelines regarding acceptability of certain objects, or the like.

In some embodiments, the method 100 may perform a contextual recognition algorithm when attempting to identify undesirable objects. A contextual recognition algorithm may analyze not only the specific objects in the media but also surrounding context, objects, or situation when identifying patterns or objects. Instead of focusing solely on the specific objects, these algorithms also account for related information such as previous occurrences, spatial relationships, or temporal sequences. By recognizing and analyzing the context in addition to the specific objects, the method 100 may better identify undesirable or impure objects based on how the objects are perceived. For example, an undesirable object may include the word “BADWORD” in audio media, and the audio media may include a conversation. If the conversation mentions an individual named “Mr. BADWORD, the method 100 may determine that the name is acceptable to leave in the media and may remove or replace other instances of “BADWORD.”

As part of processing, the impure or undesirable content may be edited. The manner of editing may be wholly configurable by the user, and may even change from one undesirable object to another. The editing, for example, may include simply removing the undesirable content. For example, a word identified as impure may be removed from a vocal portion of music, or a naked woman may be removed from video. The editing may also or instead include blurring the undesirable content. For example, a naked woman may be blurred such that her parts are unrecognizable, or an impure word may be scrambled (such that a singing sound is output but the word cannot be interpreted). The editing may also or instead include replacing the undesirable content with other, acceptable content. For example, a naked woman may have her body parts covered by a black square or a cartoon, and an impure word may be replaced with a beeping sound or another word not identified as impure (e.g., either another word by the same singer or a word or sound from a set of replacement sounds). In some embodiments, an undesirable word or phrase may be reversed (or otherwise obfuscated) and output in reverse such that the original artist's voice remains, but the word or phrase is unrecognizable. In some embodiments, an artist may provide a track or sampling of acceptable words such that each undesirable word or phrase is replaced with an acceptable word or phrase from the same artist so as to not interrupt the sound of the audio. In some embodiments, an AI algorithm may create a safe word that sounds similar to the undesirable word such that the method 100 replaces the undesirable word with the AI-generated safe word. In some embodiments, a user may configure the method 100 to include a different element for each type of undesirable content. For example, a user may control the method 100 to replace any instances of BADWORD1 with a first AI-generated word, to simply remove any instances of BADWORD2, and to replace instances of BADWORD3 with a sound bite. In some embodiments, any combination of these edits may be applied to one or more object.

In some embodiments and for video or image purification, the method 100 may remove only the undesirable objects from the video signals such that the purified video retains all other content in the media (e.g., a naked body may be removed, leaving a bed and bedroom furniture intact). In some embodiments, the method 100 may include an algorithm that creates images from remaining objects in a screen (e.g., the method 100 may fill in parts of a bed that were removed along with a naked body). In some embodiments, the method 100 may cover or replace undesirable objects with configurable elements (e.g., a solid block of color, a blurring effect, a preselected object such as a cartoon rabbit, or the like). A user of the method 100 may select from predetermined elements for replacing or covering undesirable content, may provide their own element for replacing or covering undesirable content, or any combination of predetermined elements and user-provided elements. In some embodiments, a user may configure the method 100 to include a different element for each type of undesirable content. For example, a user may control the method 100 to replace any identified drugs or drug paraphernalia with a cartoonized cannabis leaf, and to replace any naked body parts with a cartoon of Jessica Rabbit from Roger Rabbit media.

The editing may be completely autonomous (i.e., the method may automatically replace any identified undesirable media), may be fully selectable by a user (e.g., the undesirable content is identified to the user and the user selects whether and how to edit each item of undesirable content), or any combination thereof (e.g., a user may request that undesirable words in music be replaced with any acceptable words by the same singer). In fully autonomous embodiments, the method 100 may be programmed general guidelines for purification, or may be left to its own devices for purification. A user may make a selection in software to inform the method 100 of how the user prefers for the editing to occur.

After processing, the method 100 may proceed to block 120 where composition of the separated parts and chunks occurs. During composition, the method 100 utilizes the output of the processing block 118 along with the separated parts to recompose the purified media. That is, the undesirable words or objects may be removed (or replaced with acceptable objects) from their respective part and chunk (e.g., a vocal track of a specific chunk), and the remaining parts may be recomposed, resulting in purified media. In some embodiments and for audio purification, the method 100 may remove only vocals that include undesirable words such that the purified media retains all original music sounds apart from vocals.

After the purified media has been reconfigured in block 120, the purified media may be output in block 122. Purified media may refer to the original media with the undesirable object having been removed or replaced. The method 100 may output the purified media to any destination using any output means. For example, the purified media may be output as a file (e.g., MP3 file, a FLAC file, an M4A file, a .MOV file, or the like) such that it can be played or saved by the user. As another example, the purified media may be streamed to a live feed or otherwise broadcast (e.g., over the internet, over a radio channel, or the like). As additional examples, the purified media may be streamed to an audio interface, streamed to a digital to analog converter, streamed to a compact disk (CD) burner, or provided or output using any additional or alternative means.

Referring back to FIG. 5, a block diagram 300 illustrates an exemplary implementation of blocks 114 through 122 of the method 100 for audio media. After the audio media is chunked into multiple chunks, including a chunk 302, each chunk (or chunks identified as potentially containing undesirable objects) may be separated into various parts, such as vocal parts 306, drums parts 308, bass parts 310, and other parts 312. If the undesirable content of interest includes only vocals, the non-vocal parts may be recombined into a music-only media chunk 314. That is, the drums parts 308, the bass parts 310, and the other parts 312 may be combined into the music-only chunk 314. The vocal parts 306 may be enhanced to improve speech detection, and may be processed to identify undesirable words and the respective timestamp and duration of each undesirable word. The vocal parts 306 may then be edited to remove or replace the identified undesirable objects, resulting in an edited vocal part 316 that includes all vocals except for the undesirable words. The edited vocal part 316 may then be composed with the other music 314 into a combined vocal and musical part 318, which then may be output as purified media 320. In some embodiments, after enhancement, the method may analyze multiple chunks simultaneously or sequentially so that any contextual recognition algorithm may also identify context in addition to identification of the separate objects.

The method 100 of FIG. 3 may be deployed using any known deployment method. For example, software designed to implement the method 100 may be installed on a computer (e.g., a desktop, a laptop, a server, or the like) where it can process audio, video, and/or image files, stream in and out of the audio interface of the computer, stream to a web endpoint (e.g., a live YouTube® stream), or the like. As another example, software implementing the method 100 may be installed on a server and controlled by an application (an “app”) via an application programming interface (API); in that regard, the software can process audio files submitted via the API, stream in and out of an audio interface of the server, stream in and out of an interface of the client computing device, stream to a web endpoint, or the like. As another example, dedicated hardware implementing the method 100 may be installed between an audio capture device (e.g., a microphone or an input port) and another device (such as a computer or boombox coupled to the audio capture device), and the hardware may purify the media as it is captured. One skilled in the art will realize that the method 100 of FIG. 3 is not limited by any disclosure herein, and is capable of purifying any known or future media types and implementation on any type of device.

In some embodiments, the method 100 of FIG. 3 may function on edge devices such as car stereos, boomboxes, or the like. In that regard, an edge device (such as a car stereo) may receive a broadcast (e.g., FM Radio, or Sirius XM, or an internet stream) or may receive media from another source (such as a CD or smartphone) and may be connected to an output device to output the media (such as a speaker). The edge device may include a processor designed (via specific hardware design, via a software program on the processor, via firmware programming, or any combination thereof) to perform the method 100 of FIG. 3. The edge device (e.g., via a processor and a non-transitory memory that stores instructions usable by the processor) may run an instance of the method 100 to purify the media before being output. In that regard, a parent or guardian may adjust settings of a child's car stereo to purify any media output by the car stereo, and may also set a level of purification (e.g., extreme purification, minor purification, or the like). The parent may also or instead provide specific rules for how the media is to be purified (e.g., replace any curse words with a beep, to replace any dirty phrases with a recording of the parent saying to not listen to such dirty lyrics).

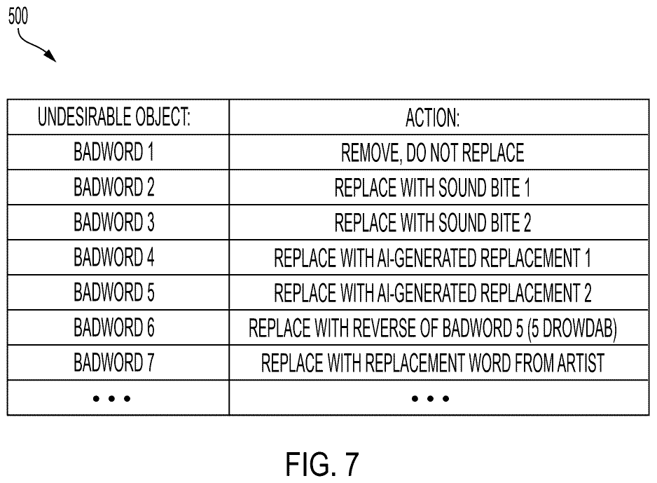

Referring now to FIG. 7, a table 500 shows exemplary actions to take for various undesirable objects in audio media. The table 500 may be populated by a system operating at least a portion of the method 100 of FIG. 3, may be populated based on user feedback, or the like. As shown, the table 500 includes various undesirable objects such as BADWORD1, BADWORD2, etc. As shown, the system may take different actions based on which undesirable object is identified in a chunk. For example, if the object BADWORD1 is identified then the system may remove BADWORD1 and not replace it with any other objects. If the object BADWORD2 is identified then the system may remove BADWORD2 and replace it with a first sound bite. If the object BADWORD4 is identified then the system may generate, using AI, a replacement object and replace BADWORD4 with the AI-generated object. As shown in the table 500, any of multiple actions may be taken based on the identified undesirable object.

Where used throughout the specification and the claims, “at least one of A or B” includes “A” only, “B” only, or “A and B.” Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A method for processing media, the method comprising:
chunking the media into chunks;
detecting an undesirable object in a chunk and identifying a location of the undesirable object in the respective chunk;
removing or replacing the undesirable object within the chunk;
recombining the chunks to create purified media; and
outputting the purified media.

2. The method of claim 1, wherein chunking the media into chunks includes chunking the media into dynamic chunks to avoid splitting at least one of full objects or undesirable objects into more than one chunk.

3. The method of claim 2, further comprising:
separating each of the dynamic chunks into its meaningful parts, wherein detecting the undesirable object and removing or replacing the undesirable object are both performed within a meaningful part of a dynamic chunk; and
recombining the respective meaningful part with remaining meaningful parts to recreate the chunks before recombining the chunks.

4. The method of claim 3, wherein:
the media includes audio;
the undesirable object includes an identified word; and
the meaningful parts include at least one vocals meaningful part and at least one instrumental meaningful part such that a recombined chunk includes the entirety of the instrumental meaningful part and the vocals meaningful part with the identified word being removed or replaced.

5. The method of claim 2, further comprising enhancing at least a portion of the meaningful parts to ease identification of objects in the meaningful parts.

6. The method of claim 1, wherein the media includes video media, and the undesirable object includes an identified shape.

7. The method of claim 6, wherein removing or replacing the undesirable object includes replacing the identified shape with a computer-generated acceptable shape.

8. The method of claim 1, wherein the media includes audio media, the undesirable object is a word or phrase, and removing or replacing the undesirable object includes replacing the word or phrase with at least one of:
a pre-recorded sound bite;
a version of the word or phrase that has been reversed to sound like a new word or phrase;
a different word or phrase obtained from at least one of the audio media or a creator of the media; or
a computer-generated acceptable replacement word or phrase.

9. The method of claim 1, wherein the media includes audio media, the undesirable object includes multiple different words or phrases, and removing or replacing the undesirable object includes selecting one of multiple actions based on identification of the word or phrase that corresponds to the respective undesirable object.

10. The method of claim 1, wherein the media includes a combination of video media and audio media, and chunking the media into chunks further includes separating the video media and the audio media from the media such that at least one of the video media or the audio media can be analyzed to identify the undesirable object.

11. The method of claim 1, wherein detecting the undesirable object is performed using a contextual recognition algorithm.

12. A system for processing media, the system comprising:
a media source configured to provide access to a piece of media;
an output device configured to output a clean version of the piece of media; and
a processor coupled to the media source and the output device and configured to:
chunk the media into chunks,
detect an undesirable object in a chunk and identify a location of the undesirable object in the respective chunk,
remove or replace the undesirable object within the chunk, and
recombine the chunks to create the clean version of the piece of media.

13. The system of claim 12, further comprising an input device configured to receive identification data identifying undesirable objects and to receive treatment data indicating how each undesirable object of the identified undesirable objects is to be treated, wherein the processor is configured to detect the undesirable object based on the received identification data and to remove or replace the undesirable object based on the treatment data.

14. The system of claim 12, wherein the processor is further configured to perform a contextual recognition algorithm to detect the undesirable object.

15. The system of claim 12, wherein the processor is configured to chunk the media into dynamic chunks to avoid splitting at least one of full objects or undesirable objects into more than one chunk.

16. The system of claim 15, wherein the processor is further configured to:
separate each of the dynamic chunks into its meaningful parts, such it detects the undesirable object and removes or replaces the undesirable object within a meaningful part of a dynamic chunk; and
recombine the respective meaningful part with remaining meaningful parts to create the chunks before recombining the chunks.

17. The system of claim 12, wherein the media includes video media, the undesirable object includes an identified shape, and the processor is further configured to remove or replace the undesirable object by at least one of:
removing the undesirable object;
replacing the undesirable object with a computer-generated acceptable shape; or
replacing the undesirable object with a pre-identified acceptable shape.

18. The system of claim 12, wherein the media includes audio media, the undesirable object is a word or phrase, and the processor is further configured to remove or replace the undesirable object by replacing the word or phrase with at least one of:
a pre-recorded sound bite;
a version of the word or phrase that has been reversed to sound like a new word or phrase;
a different word or phrase obtained from at least one of the audio media or a creator of the media; or
a computer-generated acceptable replacement word or phrase.

19. The system of claim 12, wherein the media includes audio media, the undesirable object includes multiple different words or phrases, and the processor is further configured to remove or replace the undesirable object by selecting one of multiple actions based on identification of the word or phrase that corresponds to the respective undesirable object.

20. A method for processing media, the method comprising:
receiving or accessing a piece of media that includes at least one of audio or video;
chunking the media into dynamic chunks to avoid splitting at least one of full objects or undesirable objects into more than one chunk;
detecting an undesirable object in a chunk;
identifying a location of the undesirable object in the respective chunk;
removing or replacing the undesirable object within the chunk;
recombining the chunks to create purified media; and
outputting the purified media.
